(19) United States
(12) Patent Application Publication
(10) Pub. No.: US 2011/0068739 A1
(43) Pub. Date: Mar. 24, 2011

(54) PARKING MANAGEMENT SYSTEM

(75) Inventor: NATHANIEL T. SMITH, GATES MILLS, OH (US)

(73) Assignee: RECHARGE POWER LLC, GATES MILLS, OH (US)

(21) Appl. No.: 12/888,228

(22) Filed: Sep. 22, 2010

Related U.S. Application Data
(60) Provisional application No. 61/245,241, filed on Sep. 23, 2009.

(51) Int. Cl. H02J 7/00; G06Q 10/00

(52) U.S. Cl. 320/109; 705/5

(57) ABSTRACT

Parking spaces are managed by providing: a parking space monitor with a vehicle detector responsive to the presence of a vehicle in a parking space and a power supply to recharge vehicle batteries, an alarm, a code entry device for entry of an authorization code, and a computer system programmed to receive requests to reserve a selected parking space for a selected time slot; to accept the request if the selected space is available for the selected time slot; to provide an authorization code to the requester if the request is accepted; to respond to a signal from the vehicle detector indicating the presence of a vehicle in the selected space during the selected time slot; and to activate the alarm if a vehicle is detected in the selected parking space during the selected time slot until the authorization code is entered in the code entry device by the requester.

### BACKGROUND

In many regions, parking spaces are at a premium, and this is especially true of parking spaces equipped with power supplies to recharge electric vehicles. For people who regularly drive to a location where parking is difficult to find, renting a parking space on a monthly or longer term may provide a viable solution. For those who only occasionally travel to a location where parking is hard to find, the ability to reserve a parking space in advance, especially a space where an electric vehicle can be recharged, would be advantageous.

### SUMMARY OF DISCLOSURE

According to the disclosure a group of parking spaces is managed using a computer system. The computer system enables a user to request a parking space near a particular destination beginning at a particular time and lasting for a particular duration. For convenience, this requested place, start time and duration are termed the “requested slot”. If the requested slot is available, the computer system will request payment details such as a credit card number or confirm that the requester otherwise has credit with the parking system management. The computer system then issues an authorization code to the requester. At this point the requester has a parking reservation. When the requester arrives at the requested slot, he or she enters the authorization code, and the parking transaction is then complete.

The system includes a vehicle detection device which is associated with the parking space. When a vehicle enters the space during the reserved time, the vehicle detection device activates an alarm sequence. If the authorization code is not entered within a predetermined time limit, the alarm sequence will inform the parking lot management that an unauthorized vehicle is occupying the space. In addition, audible and visual alarms may be activated at the parking space to notify the vehicle operator that parking is unauthorized and that management may take remedial action such as towing or booting the vehicle.

The system may also include a power supply for recharging electric vehicles. The power supply is controlled by a switch which in turn is controlled by the computer system. When requesting a requested slot, the user may indicate that he or she would like also to purchase electricity during the parking interval. The charge for electricity may then be added to the cost of the requested slot.

The system may be applied to all the parking spaces in a particular parking garage or district, or it may be applied to only select spaces, such as, for example premium spaces and/or spaces equipped with power supplies to recharge electric vehicles, or so called “Handicapped Spaces”, that is, spaces currently reserved for handicapped individuals. (The system would not supplant the handicapped requirement, but supplement it.)

### BRIEF DESCRIPTION OF THE DRAWINGS

FIG. 1 is a schematic illustration of a parking system that follows the teaching of this disclosure.

FIG. 2 is a schematic illustration of a parking space monitor that may be used in connection with the system of FIG. 1.

### DISCLOSURE

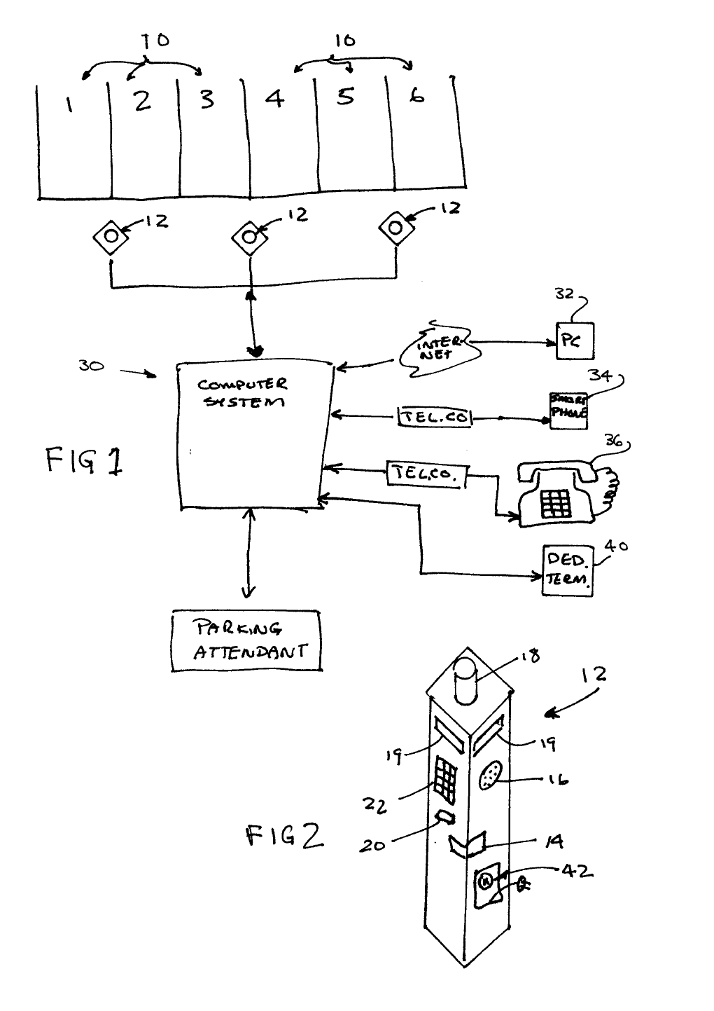

FIG. 1 shows six parking spaces 10. The spaces 10 are representative, and the actual spaces used in the parking system do not need to be adjacent to each other. The parking spaces could, for example, be on different floors of a parking garage, or located Son different streets. A parking space monitor 12 is positioned adjacent each parking space. Because the six spaces in the example are adjacent each other and because each monitor 12 is capable of servicing two adjacent spaces, only three space monitors 12 are required in this example. If the spaces are not located in pairs, then additional parking space monitors would be required so that there is a parking space monitor adjacent each space. Alternatively, the parking space monitor can be designed to service only a single space immediately adjacent the parking space monitor, so that each parking space would have its own parking space monitor even if the spaces are located in pairs.

Each parking space monitor 12 includes a vehicle detector 14 (FIG. 2) and an alarm system that may include an audible alarm tone generator 16 and a visible alarm 18. As shown, the audible tone generator 16 is a loudspeaker, but other tone generators could be used. The audible tone generator 16 may be capable of reproducing the spoken word, or simply of making a loud noise.

The visible alarm 18 may be a light mounted on the top of the parking space monitor 12. The light may be, for example a single color blinking light, or it could be capable of generating different colors such as amber and red. The visible alarm 18 may also include a computer controlled display which could, for example display the word “RESERVED”, or in a ticker tape progression state “RESERVED BEGINNING AT 2 PM TODAY”. The content of the display is controlled by the computer system 30. The display can be made to identify the space as reserved beginning at some predetermined interval before the actual reservation begins to help assure that the space is vacant and available so that the reservation may be honored.

Each parking space monitor also includes an authorization code entry device which may include, for example, barcode scanner 20 and/or keypad 22. Other code entry devices may include a microphone capable of receiving voiced communications, which, if coupled with appropriate speech recognition software, is capable of generating signals recognized by the computer system 30. The code entry device 20, 22 enables a parker to enter the authorization code which in turn is communicated to the computer system.

The vehicle detector 14 which is associated with each parking space monitor 12 is arranged to detect the presence of a vehicle in an adjacent parking slot. One vehicle detector may be capable of detecting a vehicle in each of two or more adjacent parking spaces. One such vehicle detector is shown and described in U.S. patent application Ser. No. 12/705,919, filed Feb. 15, 2010, which is incorporated herein by reference. The vehicle detectors 14 generate a distinct signal depending upon which of the adjacent spaces is occupied, and, when a vehicle is present, the signal is transmitted to the computer system 30. Other vehicle detectors are possible. For example, inductance/capacitance sensors which utilize a wire located beneath a parking space are well known. Photoelectric proximity or reflects switches can be used. Sonar based systems are also well known, and camera based systems with human or software image interpretation can be used to determine whether a vehicle is in a particular space.

The parking space monitors 12 communicate with the computer system 30. This communication may be hardwired, or it may be wholly or partially wireless. The communication may be through a network such as the internet, or through a dedicated network such as a local access network (LAN) or a combination. The communication is two-way so that the computer system can deliver instructions to the parking space monitors 12 and receive information from them.

To reserve a parking place, a user gains access to the computer system 30. The access may be provided through an internet-based link 32, through a telephone company link with a so-called smart phone such as a Blackberry or iPhone 34, or through a telephone company link with a landline telephone 36. In addition, other means of gaining access such as a dedicated terminal 40 are contemplated. An interface is provided to permit the user to access the various features of the system. The precise type of interface depends upon which of the various links to the computer system 30 the user is utilizing. For a PC, internet-based connection, a graphical user interface might be provided. The user interface allows the user to select a particular requested slot from among available slots. The user begins by identifying the time, duration, and general location of the space (s)he would like to reserve. The interface may then present her or him with one or more available spaces, and the user may then make his or her selection, identifying a particular slot or group of slots the user would prefer. The computer system 30 identifies the particular parking space that most closely matches the requested slot. The user accepts it, and makes the required payment.

Once a space has been selected, payment is arranged and confirmed. One way of accomplishing this is by using a secure link and arranging for a credit card payment. Other payment methods are possible. For example, a contractual arrangement could be made with the telephone company or other utility to have the parking charge added to a customer's bill. Likewise the parking facility owner may maintain private accounts for its regular customers. In any event, once the payment has been confirmed or arranged, the computer system 30 generates an authorization code which is then transmitted to the user.

The authorization code may be represented in one or more of several different manners. For example, the authorization code may be represented by a barcode or other machine readable code. The user may print such a code on paper or display it on a portable display such as a cell phone display. The authorization code may be a series of letters and numbers represented in a conventional fashion. The authorization code acts as the user's proof of purchase. The authorization code may be transmitted to the user as a text message, an oral message, or an image. The customer may print the image if it is a barcode or other graphic code, or may simply make a note of an alphanumeric authorization code.

When the user arrives at the reserved parking space at the selected time, he or she pulls into the space. Immediately the vehicle detector 14 senses the presence of the vehicle and sends a signal to the computer system 30, which in turn begins an alarm sequence. The alarm sequence may, for example, cause the visible alarm 18 to blink amber, giving a visual indication that an authorization code must be entered within a short time period. At the same time the loudspeaker 16 may announce that the parker has arrived in a reserved parking space and has a fixed period of time within which to authenticate his presence by entry of his authorization code. The user of the space then approaches the parking space monitor 12 and enters his authentication number. This can be done either by keying the number into the keypad 22, or by having the code scanned by barcode scanner 20. The barcode scanner 20 may read barcodes printed on paper, or may read barcodes displayed on the screen of a smart phone or other portable device. The parking space monitor 12 may also be provided with a microphone, permitting the user simply to pronounce his or her authorization code.

Voice identification software could be used to compare the parker's voice to those in a database of previously recorded and properly identified voices, in which case an identification code would not be required. Other identification techniques could also be used such as thumbprints, iris scans, or any other method for identifying an individual.

If the authorization code is entered within the allotted time, the visible alarm 18 and any other alarm is turned off. On the other hand, if the authorization code is not entered in a timely fashion, then the alarm sequence notifies a parking attendant and may at the same time change the visible alarm from one which blinks amber to one which blinks red and may change the audible alarm from a gentle voice reminding one to enter his or her authorization code to a siren or other loud alarm. In addition, the parking space monitor 12 may include cameras (not shown) which, upon detecting an unauthorized parker, may take a series of pictures in an attempt to identify the offender and/or his vehicle.

The parking space monitors 12 may also include a power supply 42 for permitting a parker to recharge the batteries of an electric vehicle. If this power supply is provided, any electricity used may be charged to the customer's account at the time the reservation is made and/or paid for. The amount of the charge may depend upon the length of time for which the spaces reserved. Alternatively, the parker may be able to prepurchase a certain amount of electricity measured, for example in kilowatt hours or simply dollars, at the time of making the reservation. The power supply 42 can be energized and controlled by the computer system 30 so that no power is provided unless an acceptable authorization code has been entered.

Coupling a parking reservation system with a recharging capability may be a particularly attractive option in a population accustomed to vehicles that travel hundreds of miles on a single tank of fuel as a transition to electric vehicles with shorter ranges occurs.

The computer system 30 is essentially conventional. Many such systems comprising databases and processors are known. For example the systems described in Chatterjee et al., U.S. Pub. 2002/0068433; Sugar et al., U.S. Pub. 2002/0029164; or Slemmer et al, U.S. Pat. No. 7,783,530 may be readily adapted for use in carrying out the functions described above by a person of ordinary skill in the art, and the disclosures of these two publications and issued patent are incorporated by reference in their entireties.

Thus it is clear that this application has described a parking management system. The computer system 30 enables a user to request a parking space 10 near a particular destination beginning at a particular time and lasting for a particular duration. If the requested slot is available, the computer system 30 will request payment details such as a credit card number or confirm that the requester otherwise has credit with the parking system management. The computer system 30 then issues an authorization code to the requester. At this point the requester has a parking reservation. When the requester arrives at the requested slot, he or she enters the authorization code, and the parking transaction is then complete.

The system includes a vehicle detection device 14 which is associated with the parking space 10. When a vehicle enters the space during the reserved time, the vehicle detection device 14 activates an alarm sequence. If the authorization code is not entered within a predetermined time limit, the alarm sequence will inform the parking lot management that an unauthorized vehicle is occupying the space. In addition, audible and visual alarms 16, 18 may be activated at the parking space to notify the vehicle operator that parking is unauthorized and that management may take remedial action such as towing or booting the vehicle.

The system may also include a power supply 42 for recharging electric vehicles. The power supply 42 is controlled by a switch which in turn is controlled by the computer system 30. When requesting a requested slot, the user may indicate that he or she would like also to purchase electricity during the parking interval. The charge for electricity may then be added to the cost of the requested slot.

The system may be applied to all the parking spaces 10 in a particular parking garage or district, or it may be applied to only select spaces, such as, for example premium spaces and/or spaces equipped with power supplies to recharge electric vehicles, or so called “Handicapped Spaces”, that is, spaces currently reserved for handicapped individuals.

1. A method of managing parking spaces comprising providing:
a parking space monitor with a vehicle detector responsive to the presence of a vehicle in
a parking space,
an alarm,
a code entry device by which a user may enter an authorization code, and
a computer system programmed:
to receive requests to reserve a selected parking space for a selected time slot;
to accept the request if the selected space is available for the selected time slot;
to provide an authorization code to the requester if the request is accepted;
to respond to a signal from the vehicle detector indicating the presence of the vehicle in the selected space during the selected time slot; and
to activate the alarm if a vehicle is detected in the selected parking space during the selected time slot until the authorization code is entered in the code entry device by the requester.

2. The method of claim 1 further including providing a user interface enabling the user interact with the computer system wherein the interface includes one or more of a graphical user interface connected through an internet connection to the computer system; a graphical user interface connected through a smart phone application, an oral user interface, a menu-driven interface for use with a telephone.

3. The method of claim 1 wherein the computer system is programmed to deny an authentication code until payment for the requested reservation has been received.

4. The method of claim 1 further including providing a power supply at the parking space and a connector for connecting a vehicle battery to the power supply to recharge the vehicle battery and a computer-system-controlled switch to turn the power supply on and off, and the computer system is programmed:
to accept a request for battery recharging power by turning the switch on if the authentication code is entered in the code entry device during the selected time slot.

5. The method of claim 4 wherein the entry device is selected from the group comprising: a bar code scanner connected to communicate with the computer system, a key pad connected to communicate with the computer system, and a telephonic interface connected to communicate with the computer system.

6. The method of claim 4 where in the alarm produces a first signal when a vehicle is first detected in the parking space and a second signal if the authorization code is not entered within a predetermined time period.
